(19) United States
(12) Patent Application Publication
(10) Pub. No.: US 2008/0000497 A1
(43) Pub. Date: Jan. 3, 2008

(54) Removal of organic-containing layers from large surface areas

(75) Inventor: Steven Verhaverbeke, San Francisco, CA (US)

Correspondence Address: SHIRLEY L. CHURCH, ESQ., P.O. BOX 81146, SAN DIEGO, CA, 92138, US

(73) Assignee: Applied Materials, Inc.

(21) Appl. No.: 11/479,349

(22) Filed: Jun. 30, 2006

(51) Int. Cl. B08B 6/00; C23F 1/00

(52) U.S. Cl. 134/1.1; 156/345.35

(57) ABSTRACT

A method of removing organic-containing layers, such as photoresists, high temperature organic layers, or organic dielectric materials, from large surface area substrates by plasma treatment at or near atmospheric pressure, wherein said large surface area substrate is transported on a conveyor belt system during said plasma treatment. The plasma is typically principally comprised of a chemically non-reactive species, such as helium. The method can be integrated in-line with the wet strip and/or wet clean, or it can be used in a stand alone system. The apparatus for carrying out the method is also described.

### BACKGROUND OF THE INVENTION

1. Field of the Invention

The present invention pertains to a method for removing organic-containing layers, such as photoresists, high temperature organic layers, and organic dielectric materials from large surface area substrates, such as a large flat panel display.

2. Brief Description of the Background Art

This section describes background subject matter related to the disclosed embodiments of the present invention. There is no intention, either express or implied, that the background art discussed in this section legally constitutes prior art.

Large flat panel displays allow for a display that is much thinner and lighter than traditional displays. Large flat panel displays are at least 500 mm by 500 mm, and are now available in much larger sizes, such as 2160 mm by 2400 mm. Large flat panel displays are used in a number of applications, such as television displays, digital information displays, and digital advertising signage. The need for more timely and up-to-date information is causing more and more companies to embrace ‘non-print’ advertising methods, such as digital advertising. As a result, rising demand for signage in public spaces has increased the worldwide market for large flat-panel public displays.

The manufacturing process for a large flat panel display, due to the size of the substrates, requires unique processing techniques, both in terms of process method and apparatus. Large flat panel display manufacturing makes use of a number of different materials, both to provide the elements of the functional device, and as temporary process structures during fabrication of the device. Since most of the devices involve the formation of layers of inter-related, intricate, and patterned structures, photoresists and high temperature organic masking materials are commonly used during patterning of underlying layers of material. A patterned photoresist is one of the temporary processing structures and typically must be removed once work on the underlying structure through openings in the photoresist is completed.

Removal of organic-containing layers using a plasma is done in semiconductor processing in a dry etch tool. However, when large substrates, such as large flat panel display substrates are involved, removal of organic-containing layers in a dry etch tool is not practical. Thus, there is a need in the art for methods for removing organic-containing layers which do not require a dry etch tool.

Scaling up a thin film transistor manufacturing method for the large surface area of the large flat panel display is a challenging prospect. There is a need in the art for manufacturing methods that work efficiently and economically when applied to a large surface area. With respect to the removal of temporary organic-containing layers, due to the varying composition of a substrate underlying the organic-containing layers, it is important that the method used to remove the organic-containing layer not disturb the underlying substrate.

Many of the currently known methods in the art for removal of an organic-containing layer in the semi-conductor industry use a low-pressure plasma, which is generated in a vacuum processing chamber. For example, U.S. Pat. No. 6,231,775, issued May 15, 2001 to Levenson et al. entitled “Process for Ashing Organic Materials from Substrates” and U.S. Pat. No. 6,951,823, issued Oct. 4, 2005, to Waldfried et al., entitled “Plasma Ashing Process” both describe the use of low-pressure plasmas for the removal of organic-containing semiconductor layers by plasma ashing. However, conventional low-pressure plasma processes require sophisticated components, such as advanced vacuum systems, which are expensive to build and maintain, especially when they are built to accommodate substrates of the size of large flat panel displays.

Some techniques have been described in the semiconductor art for the removal of an organic-containing layer, such as a photoresist, at atmospheric pressure. A few of these are outlined below.

Falkenstein described the use of dielectric barrier discharges for photoresist ashing on silicon wafers in an oxygen plasma near atmospheric pressure. He used several gap spacings, ranging from 1 mm to 20 mm, with applied frequencies ranging from 1 kHz to 40 kHz, and with pressures ranging from 100 mbar to 1500 mbar. He alleged that his results showed that for the same given power density and type of photoresist, the high-pressure discharge etch rates were comparable with the conventional low-pressure discharge etch rates. However, he found by scanning electron microscopy, that substrate surface damage occurred, especially at small gaps and high gas pressures. He proposed that the process might be improved by increasing the applied frequency. Falkenstein, Z., Applications of Dielectric Barrier Discharges, 12^{th} International Conference on High-Energy Particle Beams, Beams '98: pp. 117-120 (1998) and Falkenstein, Z., Frequency Dependence of Photoresist Ashing with Dielectric Barrier Discharges in Oxygen, Journal of Applied Physics 83: 5095-5101 (1998). As discussed above, it is very important that the surface of the underlying substrate is not damaged. Damage to this surface, even at the microscopic level, must not occur in the successful manufacture of large flat panel displays.

U.S. Pat. No. 7,025,856, issued Apr. 11, 2006, to Selwyn et al., and entitled “Processing Materials Inside an Atmospheric-Pressure Radiofrequency Nonthermal Plasma Discharge” describes and claims an apparatus for processing materials (such as silicon wafers, spools, drums, textiles, and films) in an atmospheric pressure radio-frequency non-thermal plasma. The apparatus described comprises an electrically conductive enclosure defining an interior space, with openings for introduction of a gas and for entry and exit of a material to be processed; an electrode inside the interior space; and a mechanical action for placing a material to be processed inside the interior space. The apparatus described is enclosed by a grounded casing. A first radio frequency power supply having a first phase frequency of 13.56 MHz is applied between the electrode and the grounded casing and a second radio frequency power supply having a second phase offset from the first phase by up to 180° is applied between the electrically conductive enclosure and the grounded casing. A plasma source gas containing a majority of inert gas, such as 98% helium, plus a reactive gas, such as 2% oxygen, is introduced into the interior space of the apparatus to create an atmospheric pressure plasma for processing materials. (Please see claim 1). Selwyn alleges to have a stable plasma operating region of the plasma discharge when the gas flow rate is 2.5 slpm to 40 slpm (standard liters per minute), current is less than 3.1 Amps, voltage is less than 375 Volts, and input power is less than 1180 Watts. (Please see FIGS. 3A and 3B). There is no mention of large flat substrates, such as large flat panel displays, being processed using this apparatus or method.

U.S. Patent Application Publication No. 2006/0054279, published Mar. 16, 2006, by Kim et al., and entitled “Apparatus for the Optimization of Atmospheric Plasma in a Processing System” describes an apparatus for cleaning a substrate in a reactive ion etch process. The apparatus is configured to produce an atmospheric plasma using an RF generation device. The apparatus includes a plasma forming chamber, or a set of plasma forming chambers with chamber diameters of less than 10 mils (25.4 μm). Each plasma forming chamber includes a cavity defined by a set of interior chamber walls comprised of a dielectric material. The apparatus also includes an atmospheric plasma generated by the RF generation device, the atmospheric plasma protruding from a first end of the cavity to clean the substrate. (Please see the Abstract). The reactive species comprises greater than 5% of the atmospheric plasma, and may be CF₄, SF₆, C₂F₆, O₂, or N₂. (Please see claims 5-11). It is suggested that this apparatus may be used in connection with liquid crystal displays (LCDs) of 200 mm to 300 mm, but there is no mention of using this apparatus in connection with large flat panel substrates, such as large flat panel displays.

### BRIEF DESCRIPTION OF THE DRAWINGS

FIG. 1 shows the apparatus developed for the removal of organic-containing layers from large surface areas by a plasma at atmospheric pressure, and which is described in detail in Examples 1 and 2. The gas recovery system shown for helium was not part of the apparatus used during the processing described in the examples.

FIG. 2 shows an example of a large flat panel display in relation to the upper electrode, which was a large rectangular showerhead used for dispersion of gas into the plasma chamber. FIG. 2 is described in detail in Example 1.

FIG. 3 shows a cross section of an enlarged version of a portion of the apparatus of FIG. 1 at A-A. FIG. 3 is described in detail in Example 1.

FIG. 4 shows an enlarged cross sectional view of FIG. 1 at B-B.

### DETAILED DESCRIPTION OF EXEMPLARY EMBODIMENTS OF THE INVENTION

As a preface to the detailed description presented below, it should be noted that, as used in this specification and the appended claims, the singular forms “a”, “an”, and “the” include plural referents, unless the context clearly dictates otherwise.

Use of the term “about” herein indicates that the named variable may vary to ±10%.

The present invention pertains to a method of removing an organic-containing layer from a large surface area substrate by a plasma at or near atmospheric pressure, where the substrate travels on a conveyor belt system through the plasma processing area. The invention also pertains to an apparatus for practicing the invention. The method of the present invention, described herein, is an improvement over currently used methods in the art, because it allows for the generation of a uniform plasma over a large surface area; there is no harmful disturbance of the underlying substrate surface; and there is insignificant deposit of residue from the removal process onto the underlying substrate surface during the removal process. The removal process can be integrated in-line on a conveyor belt, in combination with a wet strip and/or a wet clean step following the removal process, or the removal process can be used in a stand alone system. The removal process using an atmospheric pressure plasma does not involve the use of an expensive vacuum plasma chamber, and does not consume large amounts of water.

Organic-containing layers, such as photoresists, high temperature organic layers, or organic dielectric materials, can be removed from large surface areas, such as the surface of a large flat panel display or a solar cell array using the present invention. These large scale substrates are typically larger than about 0.5 meter by about 0.5 meter, or about 0.25 m², and currently range up to about 2160 mm by 2400 mm.

The atmospheric pressure plasma, used in the method of the present invention, comprises three particularly distinctive aspects: the composition of the plasma source gas used to create the plasma; the spacing between the upper electrode and the substrate surface; and the frequency of the RF power source.

In one embodiment of the method disclosed herein, the atmospheric pressure plasma is formed from a plasma source gas, which is principally comprised of a chemically non-reactive species (at least 95.25%), such as helium (He). One or more chemically reactive plasma source gases may be present, ranging in concentrations from about 0.005% to 4.75% of the plasma source gas. Chemically reactive plasma source gases which may be used include oxygen (O₂), which may be present in ranges from about 0.5% to 4.75%; or a reactive plasma source gas selected from the group consisting of nitrogen trifluoride (NF₃), tetrafluoromethane (CF₄), ammonia (NH₃), silane (SiH₄), and combinations thereof, which may be present in ranges from about 0.005% to about 0.015%. The addition of a chemically reactive plasma source gas is important for effective removal of the organic layer, but the quantity of this gas must be limited to prevent plasma arcing.

The spacing between the upper electrode and the organic-containing layer on the surface of the substrate is typically set to range from about 3 mm to about 15 mm. This spacing is an important component in the generation of a very high energy density plasma at atmospheric pressure without plasma arcing. In one embodiment of the present invention, the upper electrode is a gas diffuser, such as a conductive large rectangular showerhead, which is used as both an electrode and a plasma source gas distribution manifold to evenly distribute gas into the plasma processing area. Alternatively, the showerhead may be a shape other than rectangular, and/or multiple smaller showerheads may be used instead of one large showerhead.

The atmospheric pressure plasma is generated using an RF frequency power source. The frequency of the RF power source is typically about 27 MHz or about 54 MHz. The frequency of the RF power source is another important variable in generating a very high energy density plasma source, without plasma arcing, at atmospheric pressure. One skilled in the art may select a different frequency depending on the particular processing apparatus used and the plasma source gasused, in view of the present disclosure.

A substrate to be processed moves through the plasma processing area on a conveyor belt; and, because the plasma processing enclosure is open at each end to permit the conveyor belt to move through, plasma processing gases and species may escape through the openings. A gas curtain is used to create a dynamic seal to contain the plasma within a plasma processing enclosure, thereby preventing leakage of the gases and plasma species from the plasma processing enclosure. The gas curtain may be created using any gas which is compatible with the plasma process used to strip the organic-containing layer. In a typical embodiment, the gas curtain is created with air, He, or an inert gas other than He. This is important both in terms of preventing contamination of the plasma processing area by ambient gases present surrounding the plasma processing enclosure and preventing the loss of expensive and possibly toxic materials from the plasma processing area into the ambient atmosphere. The gas curtain creates a positive pressure at the ends of the plasma processing enclosure, creating a back pressure within the plasma processing enclosure.

Thus, for example, and not by way of limitation, when the plasma source gas contains about 95% He, and when the He gas or plasma species move towards the edge of the plasma processing enclosure most of this material is stopped by the gas curtain. Some of the He gas and plasma species may be redirected back into the central portion of the plasma processing enclosure, while the majority of the He gas and active species which leave the plasma processing enclosure are drawn up with the gas of the gas curtain and are directed to a gas centrifuge, where the gases present are separated out for recycling. Recycled plasma source gases can be used again in the plasma processing enclosure.

The apparatus of the present invention includes a conveyor belt for moving substrates to be processed. In one embodiment, this conveyor belt system is grounded by a grounding metal plate (lower electrode), which may be located in a stationary position, below the conveyor belt. In this embodiment, the conveyor belt is conductive. In another embodiment, a grounding electrode is not used, but the large flat panel substrate serves to dissipate the charge/energy from the plasma species. In this embodiment, the conveyor belt can be made of a non-conductor, since it does not need to conduct to an underlying electrode.

As discussed above, the method of removing an organic layer from a large surface area substrate by a plasma at or near atmospheric pressure, where the substrate travels on a conveyor belt system through the plasma processing area, is an improvement over currently used methods in the art because: there is insignificant deposit of residue from the removal process onto the underlying surface; the method can be integrated on an in-line conveyor belt with a wet strip and/or wet clean following the removal process, or the removal process can be used in a stand alone organic-based film removal system; and, the method does not consume large quantities of water which requires subsequent clean up.

### EXAMPLE EMBODIMENTS OF THE INVENTION

### Example 1

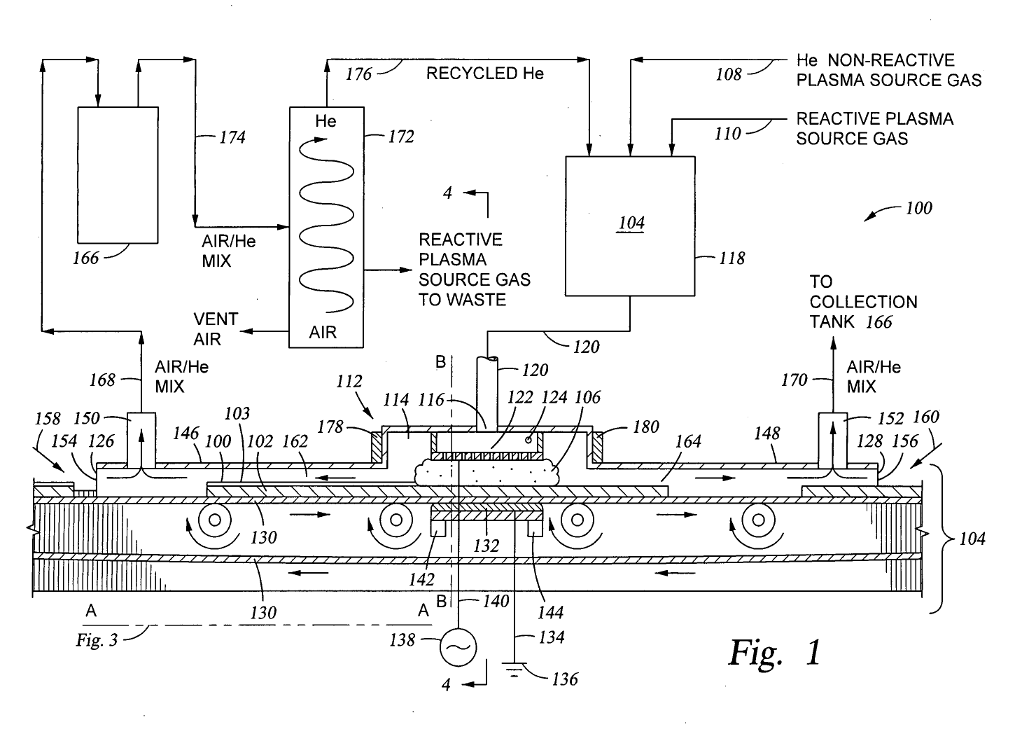

FIG. 1 shows an embodiment apparatus 100, which may be used for the removal of organic-containing layers 101 from the surface of large flat panel substrates 102 of the kind used for large flat panel display products. The apparatus 100, and a method for using the apparatus 100, is described in detail below.

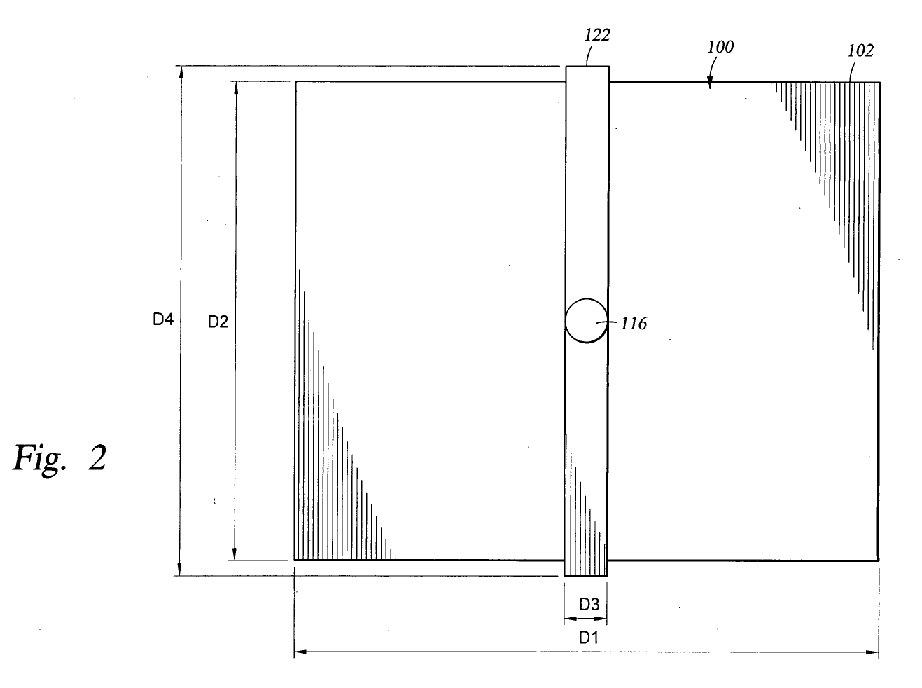

The large flat panel substrates 102 processed in apparatus 100 may be as large as several meters in width and length. FIG. 2 shows an example of a large flat panel substrate 102 with a length D₁ and a width D₂. In the apparatus used for experimentation, the large flat panel substrate 102 processed, D₁ was about 2400 mm and D₂ was about 2160 mm.

The apparatus 100 illustrated in FIG. 1 uses a plasma 106 at or near atmospheric pressure for removal of the organic-containing layer 101 by a plasma. The plasma is formed from a plasma source gas mixture 104, which is principally comprised (at least 95.25%) of a chemically non-reactive plasma source gas 108, such as He. One or more chemically reactive plasma source gases 110 are present, ranging in concentrations from about 0.005% to 4.75%. Examples of such chemically reactive plasma source gases 110 include oxygen (O₂), which may be present in ranges from about 0.5% to 4.75%; or a chemically reactive plasma source gas selected from the group consisting of nitrogen trifluoride (NF₃), tetrafluoromethane (CF₄), ammonia (NH₃), silane (SiH₄), and combinations thereof, which may be present in ranges from about 0.005% to about 0.015%.

The chemically non-reactive plasma source gas 108 and the one or more chemically reactive plasma source gases 110 are mixed together in the plasma source gas mixing tank 118 to prepare the plasma source gas mixture 104. This plasma source gas mixture 104 is then transferred through piping 120 from the plasma source gas mixing tank 118 and through gas inlet 116, into a gas dispersion manifold 122, such as a showerhead.

The gas dispersion manifold 122, is typically a large rectangular, conductive device, such as the showerhead shown in FIG. 1. FIG. 2 shows an example of a showerhead 122, which has a width of D₃ and a length of D₄. In the apparatus used for experimentation D₃ was about 200 mm and D₄ was about 2300 mm. In an alternate embodiment (not shown in the Figures), the gas dispersion manifold 122 may be one or more smaller showerheads, which may or may not be rectangular in shape.

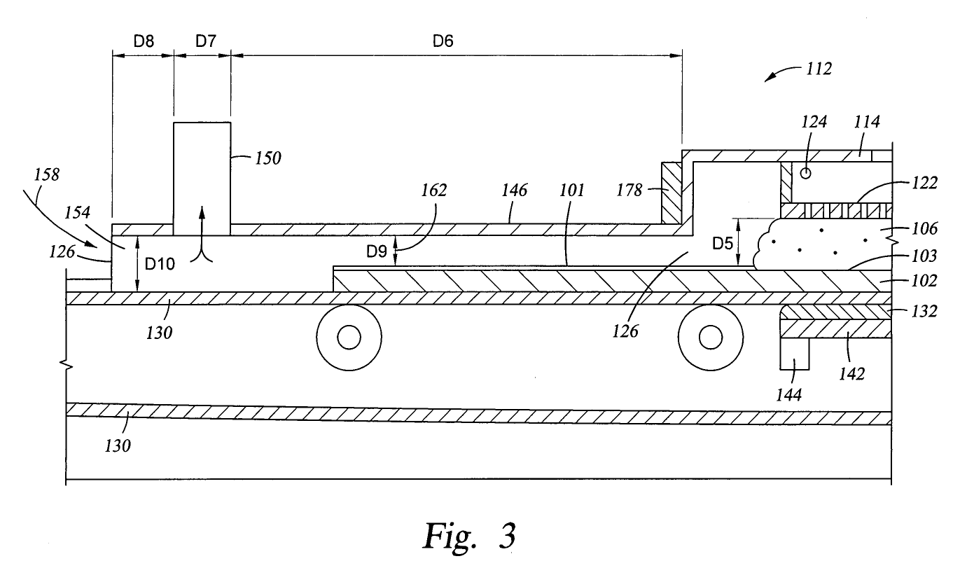

As shown in FIG. 3, the large rectangular showerhead 122 is positioned a distance D₅ from the organic-containing layer 101 on the surface of the large flat panel 102, wherein D₅ ranges in distance from about 3 mm to about 15 mm.

The concentrations of the plasma source gases 108 and 110 in the plasma source gas mixture 104 are monitored using a gas sensor 124, which is shown in FIG. 1 within the interior of the showerhead 122, and which may, in the alternative, be present in the plasma source gas mixing tank 118 or in piping 120. When the concentrations of the plasma source gases 108 and 110 are lower or higher than the desired amounts, then the flow of plasma source gases 108 and 110 will be adjusted accordingly.

The plasma source gas mixture 104 is dispersed by the showerhead 122 into the plasma processing area 114, where the plasma source gas mixture 104 is converted to a plasma 106 using an RF power source 138 operated at a frequency of about 27 MHz or about 54 MHz. One skilled in the art may select a different frequency depending on the particular processing apparatus used and the plasma source gas used, in view of the present disclosure. The RF power source 138 is connected by lead wire 140 to an electrode, which may also be the showerhead 122, as shown in FIG. 1. Magnets 178 and 180 may be located on the outside of the plasma processing area 114 to control the location of the plasma 106.

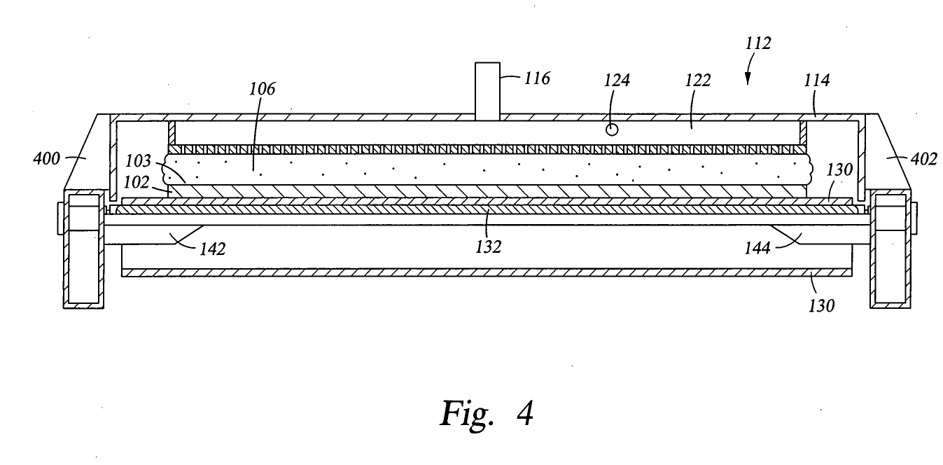

The plasma processing area 114 is located within the plasma processing enclosure 112. The plasma processing enclosure 112, as shown in FIG. 1, has openings 126 and 128 on two opposing ends of the enclosure to allow for the passage of a conveyor belt 130, upon which large flat panel displays 102 are transported into and out of the plasma processing enclosure 112 where plasma 106 is used for removing the organic-containing layer 101 from a surface 103 of the large flat panel display 102. The other two opposing sides of the plasma processing enclosure 112 are closed in by plasma processing are closed in by plasma processing enclosure walls 400 and 402, as shown in the schematic cross-sectional view in FIG. 4.

As shown in FIG. 1, beneath the conveyor belt 130 is a grounding electrode 142 that is grounded by lead wire 134, which is connected to the ground 136. The grounding electrode 142 may be fixed in position by a bracket 144. Bracket 144 may serve as the grounding connection in place of lead wire 134. The conveyor belt 130 is composed of a conductive material to allow the passage of charge from the plasma 106 to ground 136. In an alternate embodiment (not shown in the Figures), a grounding electrode is not used and the large flat panel substrate 102 serves to dissipate the charge/energy from the plasma 106.

A heater 132 is located beneath the conveyor belt 130, as shown in FIG. 1, to heat the large flat panel substrate 102 to a desired temperature, to aid in the removal of the organic-containing layer 101.

FIGS. 1 and 3 shows the plasma processing enclosure openings 126 and 128, which extend away from the plasma processing enclosure 112 as extensions 146 and 148. Gas outlets 150 and 152 are positioned along the extensions 146 and 148 a distance of D₆ away from the plasma processing area 114. The diameter of the gas outlets 150 and 152 is D₇. The extensions 146 and 148 of the plasma processing enclosure 112 have termini 154 and 156 that have openings 126 and 128, located a distance of D₈ away from the gas outlets 150 and 152. In the apparatus used for experimentation, D₆ was about 16 mm, D₇ was about 1 mm, and D₈ was about 16 mm.

The openings 126 and 128 at the termini 154 and 156 result in a gap 162 between the top of the extensions 146 and 148 and the upper surface 103 of the large flat panel substrate 102, wherein the gap has a length of D₉. A gap 164 is also formed between the top of the extensions 146 and 148. D₉ was less than 0.4 mm in height in the apparatus used to carry out the initial trials, and with respect to that apparatus, D₉ should range from about 0.1 mm to about 0.2 mm in height. When the gap 162 height D₉ reached 0.4 mm, leakage of He from the plasma processing area 114 greatly increased. D₁₀, the height of the opening 164 into the plasma processing enclosure 112 was 2 mm in the apparatus used to carry out the initial trials, but may range from 0.5 mm to 2.5 mm in height. It is preferable for D₁₀ to range from 0.5 mm to 1.0 mm in height, and more preferable for D₁₀ to range from 0.7 mm to 0.8 mm in height, because as D₁₀ reaches 0.8 mm in height, leakage of He from the plasma processing area 114 greatly increased.

Gap 162 and the height of the opening 164 into the plasma processing enclosure 112 create openings where He species and chemically reactive gas species from the plasma 106 may leak out from the plasma processing enclosure 112 into the ambient environment, and where ambient air may leak into the plasma processing enclosure 112. To minimize the leak of He species and chemically reactive gas species from the plasma 106, a gas curtain is used to create a dynamic seal. The gas curtain is generated by the flow of a gas 158 and 160 (shown in FIGS. 1 and 3) into the termini 154 and 156 of the plasma processing enclosure 112 and out through the gas outlets 150 and 152. The gas used for the gas curtain may be ambient air, or may be He, or an inert gas other than He.

As shown in FIG. 1, gas outlets 150 and 152 may be connected to a collection tank 166 via piping 168 and 170, respectively, to collect the gas from the gas curtain, in addition to the He species and the chemically reactive species which are drawn into gas outlets 150 and 152. The contents of the collection tank 166 may then be routed to a gas centrifuge 172, via piping 174. The gas centrifuge 172 is used to separate out plasma source gases, such as He and, optionally, the gas curtain gas for recycling. The recycled plasma source gases may be directed back to the plasma source gas supply mixing tank 118 via piping 176, and may be used again as part of the plasma source gas mixture 104. The gas centrifuge 172 may also be used to separate out air, which can be vented, and other gas curtain gases, which may be reused or may be collected as a waste gas. If other gases, such as He or an inert gas other than He, are used for the gas curtain, these gases can also be separated out by the gas centrifuge and recycled as is appropriate (not shown in the Figures).

### Example 2

The method of removal of an organic containing layer from the surface of a large flat panel substrate, which is described in this example, may be carried out in an apparatus of the kind shown in FIG. 1. This method is used to remove organic-containing layers 101, such as photoresists, high temperature organic layers, and organic dielectric materials, from the surface of large flat panel substrates 102 of the kind used for large flat panel display products. This method uses a plasma 106 for removing the organic layers at or near atmospheric pressure.

The plasma is formed from a plasma source gas mixture 104, which is principally comprised (at least 95.25%) of a chemically non-reactive plasma source gas 108, such as He. One or more chemically reactive plasma source gases 110 may be present, ranging in concentrations from about 0.005% to 4.75%. Examples (not by way of limitation) of such chemically reactive plasma source gases 110 include oxygen (O₂), which may be present in ranges from about 0.5 % to 4.75%; or a chemically reactive plasma source gas selected from the group consisting of nitrogen trifluoride (NF₃), tetrafluoromethane (CF₄), ammonia (NH₃), silane (SiH₄), and combinations thereof, which may be present in ranges from about 0.005% to about 0.015%.

The chemically non-reactive plasma source gas 108 and the one or more chemically reactive plasma source gases 110 are mixed together in the plasma source gas mixing tank 118 to prepare a plasma source gas mixture 104. This plasma source gas mixture 104 is then transferred through piping 120 from the plasma source gas mixing tank 118 and through gas inlet 116, into a gas dispersion device 122, such as a showerhead.

The plasma source gas mixture 104 is dispersed by the showerhead 122 into the plasma processing area 114, where the plasma source gas mixture 104 is converted to a plasma 106 using an RF power source 138 operated at a frequency of about 27 MHz or about 54 MHz. One skilled in the art may select a different frequency depending on the particular processing apparatus used and the plasma source gas used, in view of the present disclosure.

A large flat panel substrate 102 with an organic-containing layer 101 on its surface is transported into the plasma processing enclosure 112 on the conveyor belt 130. As the flat panel 102 enters the plasma processing enclosure 112, the flat panel 102 is heated to a temperature ranging from about 50° C. to about 300° C. by resistive heater 132, and the organic-containing layer 101 is removed. Once the organic-containing layer 101 is removed from the flat panel 102, the flat panel 102 is transported out of the plasma processing enclosure 112 on the conveyor belt 130.

Minimal plasma source gases are lost to the environment outside of the apparatus 100 by way of leakage at the termini 154 and 156. Leakage is prevented by a dynamic seal which is created by the gas curtain described above, which flows into the termini 154 and 156 and which is drawn up through the gas outlets 150 and 152.

Some plasma source gas materials are also drawn up into the gas outlets 150 and 152. The plasma source gases are then recovered in collection tank 166, separated from other gases in gas centrifuge 172, and are available for recycle as described above.

Pressure in the plasma processing area 114 ranges from about 100,000 pascals to about 100,010 pascals, and is typically about 10 pascals above atmospheric pressure. The suction pressure in gas outlets 150 and 152 ranges from about 99,950 pascals to about 99,990 pascals, and is typically about 10 pascals below atmospheric pressure.

There is a gap 162 between the top of the extension 146 and the large flat panel substrate 102, which has a height of D₉. To determine the affect that D₉ has on the rate at which plasma source gas mixture 104 passed through the apparatus, D₉ was varied from 0.1 mm to 0.2 mm and 0.4 mm. The results were as follows: At a gap (D₉) of 0.1 mm, the consumption of the plasma source gas mixture 104 is 0.4 L/min/m. When the gap (D₉) is increased to 0.2 mm, the consumption of the plasma source gas mixture 104 is 3.0 L/min/m. When the gap (D₉) is further increased to 0.4 mm, the consumption of plasma source gas mixture 104 jumps to 21.7 L/min/meter.

To assess the capability of the apparatus to remove an organic-containing layer with an atmospheric pressure plasma, baked photoresist was removed from the surface of glass substrates. The plasma source gas mixture 104 contained about 97% He and about 3 % O₂ gas and was supplied to the plasma processing area 114 at a rate of 50 L/min. The hard baked photoresist having a thickness of about 1 μm was on a glass flat panel having a thickness of about 0.7 mm, a length of about 300 mm, and a width of about 200 mm. A resistive heater 132 set to about 270° C. was in contact with the glass flat panel 102. The speed of the conveyor belt 130 was about 300 mm/min, providing a residence time of a flat panel within the plasma processing area 114 of about 1 min. RF power at a frequency of 27.12 MHz and at about 2 KW was supplied to the electrode 122. The photoresist was removed in less than 11 seconds, with a total consumption of about 9 L of the plasma source gas mixture 104. At a price of about $1 per 280 L, the total cost of He gas used was about 3 cents.

The method of organic layer removal with an atmospheric pressure plasma, when applied to a metal-containing organic layer, such as a photoresist layer doped with high dose implants of Boron (B) at a dose of 2E15 or of Arsenic (As) at a dose of 5E15 was also assessed. The plasma source gas mixture 104 contained about 99% He gas, about 1 % O₂ gas, and about 0.01% NF₃ gas, and was supplied at a rate of about 50 L/min. The implanted photoresist having a thickness of about 1 μm was on a glass flat panel having a thickness of about 0.7 mm, a length of about 300 mm, and a width of about 200 mm. A resistive heater 132 set to about 80° C. was in contact with the glass flat panel 102. The speed of the conveyor belt 130 was about 60 mm/min, providing a residence time of a flat panel within the plasma processing area 114 of about 5 min. RF power at a frequency of 27.12 MHz and at about 2 KW was supplied to the electrode 122. The B or the As implanted photoresist layer was removed in about 2.5 minutes, with a total consumption of about 125 L of the plasma source gas mixture 104 for each. Although the removal time and the consumption of plasma source gas mixture 104 was significantly greater, this can be attributed to the unusually high dose of doping of the implanted photoresist layers. These high doses are not very common in the manufacturing process of flat panels.

While the invention has been described in detail above with reference to several embodiments, these embodiments are not intended to limit the scope of the invention. Various modifications within the scope and spirit of the invention will be apparent to one skilled in the art, who can expand the embodiments to correspond with the subject matter of the invention claimed below.

We claim:

1. A method of removing an organic-containing layer from a surface of a large surface area substrate by a plasma treatment at or near atmospheric pressure, wherein said substrate travels through a plasma processing area on a conveyor belt, and wherein said plasma comprises chemically non-reactive species ranging in concentration from about 95% to about 100% of the plasma and chemically reactive species ranging in concentration from about 0.005% to 4.75% of the plasma.

2. A method in accordance with claim 1, wherein said large surface area substrate is a large flat panel surface that is comprised of glass.

3. A method in accordance with claim 2, wherein said large surface area substrate ranges in length from about 300 mm to about 2500 mm and ranges in width from about 300 mm to about 2500 mm.

4. A method in accordance with claim 3, wherein the large surface area ranges in length from about 500 mm to about 2160 mm and ranges in width from about 500 mm to about 2400 mm.

5. A method in accordance with claim 2 or claim 3, wherein a thickness of said large area substrate ranges from about 0.5 mm to about 1 mm.

6. A method in accordance with claim 5, wherein a thickness of said organic-containing layer ranges from about 0.5 μm to about 2 μm.

7. A method in accordance with claim 1, wherein said organic-containing layer is selected from the group consisting of photoresist material, high temperature organic material, and organic dielectric material.

8. A method in accordance with claim 7, wherein the organic-containing layer is photoresist material.

9. A method in accordance with claim 1, wherein said chemically non-reactive species is helium (He).

10. A method in accordance with claim 1 or claim 9, wherein a chemically reactive species is oxygen (O₂).

11. A method in accordance with claim 10, wherein a concentration of said O₂ ranges from about 0.5% to 4.75%.

12. A method in accordance with claim 9, wherein said chemically reactive species is selected from the group consisting of nitrogen trifluoride (NF₃), tetrafluoromethane (CF₄), ammonia (NH₃), silane (SiH₄), and combinations thereof.

13. A method in accordance with claim 12, wherein a concentration of said chemically reactive species ranges from about 0.005% to about 0.015%.

14. A method in accordance with claim 1, wherein RF power at a frequency of about 27 MHz or at a frequency of about 54 MHz is used for the generation of said plasma.

15. A method in accordance with claim 1, wherein a curtain of gas is used to create a dynamic seal to prevent leakage of said chemically non-reactive species and said chemically reactive species of the plasma from said plasma processing area.

16. A method in accordance with claim 15, wherein said curtain of gas is air or an inert gas.

17. A method in accordance with claim 13, wherein said inert gas is helium.

18. A method in accordance with claim 1, wherein gases and species from said plasma processing area are recycled for reuse.

19. An apparatus for removing an organic-containing layer from a surface of a large surface area substrate by exposing said organic-containing layer to a plasma at or near atmospheric pressure, wherein said apparatus comprises a conveyor belt system for transportation of said substrate, a plasma processing area into which plasma source gases for creating chemically non-reactive species and chemically reactive species are supplied, wherein an RF power source is applied to create said plasma.

20. An apparatus for removing an organic-containing layer from a large surface area substrate by exposure of said organic-containing layer to a plasma at or near atmospheric pressure, wherein said apparatus comprises:
(1) a plasma processing enclosure;
(2) a conveyor belt which passes through the plasma processing enclosure;
(3) a gas inlet in the plasma processing enclosure for the introduction of a plasma source gas mixture used for the generation of the plasma;
(4) a plasma generating electrode which is positioned about 3 mm to about 15 mm apart from the surface of a large area substrate which is processed in said plasma processing enclosure;
(5) gas inlets and outlets on the two opposing sides of the plasma processing enclosure for generating a dynamic seal gas curtain around the plasma processing area;
(6) an RF power source with a frequency of about 27 MHz or about 54 MHz; and
(7) a means for recycling said plasma source gas used for the generation of said plasma.

21. An apparatus in accordance with claim 20, wherein a grounding metal electrode plate is located beneath said large surface area substrate.

22. An apparatus in accordance with claim 21, wherein said grounding metal electrode plate is located beneath said conveyor belt.

23. An apparatus in accordance with claim 22, wherein the conveyor belt is composed of electrically conductive material.

24. An apparatus in accordance with claim 20, wherein said apparatus includes a plasma source gas distribution manifold.

25. An apparatus in accordance with claim 24, wherein said plasma source gas distribution manifold also functions as said plasma generating electrode.
